(19) United States
(12) Patent Application Publication
(10) Pub. No.: US 2016/0086264 A1
(43) Pub. Date: Mar. 24, 2016

(54) Market Dynamic Variable Price Limits

(71) Applicant: Chicago Mercantile Exchange, Inc., Chicago, IL (US)

(72) Inventors: John Labuszewski, Westmont, IL (US); Daniel Grombacher, Evanston, IL (US); John Kerpel, Chicago, IL (US); Sandra Ro, London (GB); Lori Aldinger, Naperville, IL (US); David Boberski, Westport, CT (US); James Boudreault, Palatine, IL (US); Jonathan Kronstein, Elmhurst, IL (US)

(21) Appl. No.: 14/489,793

(22) Filed: Sep. 18, 2014

(51) Int. Cl. G06Q 40/04

(52) U.S. Cl. CPC G06Q 40/04

(57) ABSTRACT

Data indicative of an instruction to calculate an upper price limit and a lower price limit corresponding to a financial product type may be received. In response to that instruction, data representing price information for each of N prior times may be accessed. A statistical analysis of the price information may be performed to obtain a price limit range. The upper lower price limits may be calculated based on the price limit range and based on a price value for instances of the financial product.

### BACKGROUND

Futures contracts, options on futures contracts and numerous other types of financial products are traded using exchanges established for such trading. Such trading may involve potential purchasers of a financial product submitting orders known as bids. A bid order may include a bid price representing the value at which a potential buyer is willing to purchase the financial product in question. Similarly, potential sellers of a financial product may submit orders known as offers or asks. An ask order may include an offer (ask) price representing the value at which a potential seller is willing to sell the financial product in question. A bid order may be matched to an ask order so as to execute a trade in the financial product that is the subject of the matched bid and ask.

Many types of markets utilize price limits. If an incoming order has an associated bid or ask price within the price limits, the order may be accepted for further processing (e.g., entry into an order database and evaluation for potential matching against other orders). If an incoming order has an associated bid or ask price that is outside the price limits, the order is rejected. Price limits may act as a “circuit breaker” and help to prevent extremely large short term price swings that could potentially cause market disruption. Price limits may also help to filter orders that are unlikely to be matched. For example, a rejected order may be the result of an input error by the party submitting the order.

Current systems set price limits within a fixed range above and below a current market price for a particular type of financial product. This fixed range is sometimes arbitrary and may not always cover an appropriate range of prospective market prices with a reasonable degree of probability.

### SUMMARY

This Summary is provided to introduce a selection of concepts in a simplified form that are further described below in the Detailed Description. This Summary is not intended to identify key features or essential features of the invention.

In some embodiments, a computer system may receive data indicative of an instruction to calculate an upper price limit and a lower price limit corresponding to a financial product type. In response to that instruction, the computer system may access data representing price information for each of N prior times. The computer system may then perform a statistical analysis of the price information to obtain a price limit range. The upper price limit and the lower price limit may be calculated by the computer system based on the price limit range and based on a price value for instances of the financial product. The computer system may then store the calculated upper and lower price limits. The price limits may then be used to determine whether incoming orders for one or more instances of the financial product type should be rejected or should be accepted for further processing.

Embodiments include, without limitation, methods for processing data associated with price limits for one or more types of financial products, computer systems configured to perform such methods and non-transitory computer-readable media storing instructions executable by a computer system to perform such methods.

### BRIEF DESCRIPTION OF THE DRAWINGS

Some embodiments are illustrated by way of example, and not by way of limitation, in the figures of the accompanying drawings and in which like reference numerals refer to similar elements.

FIG. 1 shows an exemplary trading network environment for implementing trading systems and methods according to at least some embodiments.

FIG. 2 is a flow chart showing operations performed in connection with price limit calculation according to some embodiments.

FIG. 3 is a flow chart showing operations performed in connection with price limit calculation according to some additional embodiments.

FIG. 4 is a flow chart showing operations performed in connection with price limit calculation according to some further embodiments.

FIG. 5 is a flow chart showing operations performed in some embodiments in connection with implementation of price limits.

### DETAILED DESCRIPTION

In the following description of various embodiments, reference is made to the accompanying drawings, which form a part hereof, and in which various embodiments are shown by way of illustration. It is to be understood that there are other embodiments and that structural and functional modifications may be made. Embodiments of the present invention may take physical form in certain parts and steps, examples of which will be described in detail in the following description and illustrated in the accompanying drawings that form a part hereof.

Various embodiments may comprise a method, a computer system, and/or a computer program product. Accordingly, one or more aspects of one or more of such embodiments may take the form of an entirely hardware embodiment, an entirely software embodiment and/or an embodiment combining software and hardware aspects. Furthermore, such aspects may take the form of a computer program product stored by one or more non-transitory computer-readable storage media having computer-readable program code, or instructions, embodied in or on the storage media. The term “computer-readable medium” or “computer-readable storage medium” as used herein includes not only a single medium or single type of medium, but also a combination of one or more media and/or types of media. Such a non-transitory computer-readable medium may store computer-readable instructions (e.g., software) and/or computer-readable data (i.e., information that may or may not be executable). Any suitable computer readable media may be utilized, including various types of non-transitory computer readable storage media such as hard disks, CD-ROMs, optical storage devices, magnetic storage devices, FLASH memory and/or any combination thereof. The term “computer-readable medium” or “computer-readable storage medium” could also include an integrated circuit or other device having hard-coded instructions (e.g., logic gates) that configure the device to perform one or more operations.

Aspects of method steps described in connection with one or more embodiments may be executed by one or more processors associated with a computer system (such as exchange computer system 100 described below). As used herein, a “computer system” could be a single computer or could comprise multiple computers. When a computer system comprising multiple computers performs a method, various steps could be performed by different ones of those multiple computers. Processors of a computer system may execute computer-executable instructions stored on non-transitory computer-readable media. Embodiments may also be practiced in a computer system forming a distributed computing environment, with tasks performed by remote processing devices that are linked through a communications network. In a distributed computing environment, program modules may be located in both local and remote computer storage media including memory storage devices.

### Exemplary Operating Environment

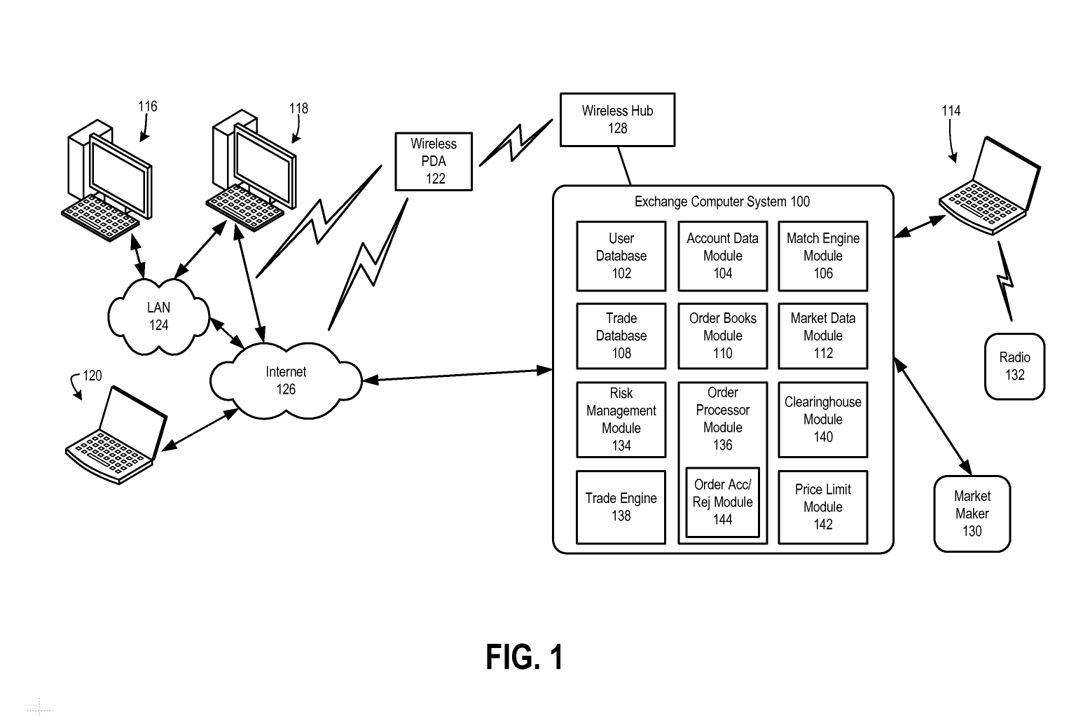

Aspects of at least some embodiments can be implemented with computer systems and computer networks that allow users to communicate trading information. An exemplary trading network environment for implementing systems and methods according to at least some embodiments is shown in FIG. 1. The implemented systems and methods can include systems and methods, such as are described herein, that facilitate data processing and other activities associated with calculation and implementation of price limits.

Computer system 100 can be operated by a financial product exchange and configured to perform operations of the exchange for, e.g., trading and otherwise processing various financial products. Financial products of the exchange may include, without limitation, futures contracts, options on futures contracts, other types of options, and other types of derivative contracts. Financial products traded or otherwise processed by the exchange may also include over-the-counter (OTC) products such as OTC forwards, OTC options, OTC swaps, etc. Financial products traded through the exchange may also or alternatively include other types of financial interests, including without limitation stocks, bonds and or other securities (e.g., exchange traded funds), foreign currencies, and spot market trading of commodities.

Computer system 100 receives orders for financial products, matches orders to execute trades, transmits market data related to orders and trades to users, and performs other operations associated with a financial product exchange. Exchange computer system 100 may be implemented with one or more mainframe, desktop or other computers. In one embodiment, a computer device uses a 64-bit processor. A user database 102 includes information identifying traders and other users of exchange computer system 100. Data may include user names and passwords. An account data module 104 may process account information that may be used during trades. A match engine module 106 is included to match prices and other parameters of bid and offer orders. Match engine module 106 may be implemented with software that executes one or more algorithms for matching bids and offers.

A trade database 108 may be included to store information identifying trades and descriptions of trades. In particular, a trade database may store information identifying the time that a trade took place and the contract price. An order book module 110 may be included to store prices and other data for bid and offer orders, and/or to compute (or otherwise determine) current bid and offer prices. A market data module 112 may be included to collect market data, e.g., data regarding current bids and offers for futures contracts, futures contract options and other derivative products. Module 112 may also prepare the collected market data for transmission to users. A risk management module 134 may be included to compute and determine a user's risk utilization in relation to the user's defined risk thresholds. An order processor module 136 may be included to decompose delta based and bulk order types for further processing by order book module 110 and match engine module 106. Order processor module 136 may also include an order acceptance/rejection (“Acc/Rej”) module 144 that screens incoming orders to determine if order prices are within price limits that have been established for a particular type of financial product.

A clearinghouse module 140 may be included as part of exchange computer system 100 and configured to carry out operations of a clearinghouse of the exchange that operates computer system 100. Module 140 may receive data from and/or transmit data to trade database 108 and/or other modules of computer system 100 regarding trades of futures contracts, futures contracts options, and other financial products traded through the exchange that operates system 100. Clearinghouse module 140 may facilitate the financial product exchange (or a clearinghouse of the exchange) acting as one of the parties to every traded contract or other product. For example, computer system 100 may match an offer by party A to sell a futures contract, an option or another exchange-traded financial product with a bid by party B to purchase a like exchange-traded financial product. Module 140 may then create an exchange-traded financial product between party A and the exchange clearinghouse and a second exchange-traded financial product between the exchange clearinghouse and party B. Module 140 may similarly create offsetting contracts when creating contracts as a result of an option exercise and/or may select option grantors to fulfill obligations of exercising option holders. Module 140 may also be configured to perform other clearinghouse operations. As a further example, module 140 may maintain margin data with regard to clearing members and/or trading customers. As part of such margin-related operations, module 140 may store and maintain data regarding the values of various options, futures contracts and other interests, determine mark-to-market and final settlement amounts, confirm receipt and/or payment of amounts due from margin accounts, confirm satisfaction of delivery and other final settlement obligations, etc.

Price limit module 142 generates, stores and processes data regarding price limits for various types of financial products. Various operations performed by price limit module 142 in at least some embodiments are further described below. Operations associated with establishing and implementing price limits may also and/or alternatively be performed by other modules of computer system 100.

Each of modules 102 through 144 could be implemented as separate software components executing within a single computer, separate hardware components (e.g., dedicated hardware devices) in a single computer, separate computers in a networked computer system, or any combination thereof (e.g., different computers in a networked system may execute software modules corresponding more than one of modules 102-142). When one or more of modules 102 through 144 are implemented as separate computers in a networked environment, those computers may be part of a local area network, a wide area network, and/or multiple interconnected local and/or wide area networks.

Exchange computer system 100 may also communicate in a variety of ways with devices that may be logically distinct from computer system 100. For example, computer device 114 is shown directly connected to exchange computer system 100. Exchange computer system 100 and computer device 114 may be connected via a T1 line, a common local area network (LAN) or other mechanism for connecting computer devices. Also shown in FIG. 1 is a radio 132. The user of radio 132 (e.g., a trader or exchange employee) may transmit orders or other information to a user of computer device 114. The user of computer device 114 may then transmit those orders or other information to exchange computer system 100 using computer device 114.

Computer devices 116 and 118 are coupled to a LAN 124 and may communicate with exchange computer system 100 via LAN 124. LAN 124 may implement one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics, radio links or other media.

A wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet. Computers 116, 118 and 120 may communicate with each other via the Internet 126 and/or LAN 124.

One or more market makers 130 may maintain a market by providing constant bid and offer prices for a derivative or security to exchange computer system 100. Exchange computer system 100 may also include trade engine 138. Trade engine 138 may, e.g., receive incoming communications from various channel partners and route those communications to one or more other modules of exchange computer system 100.

One skilled in the art will appreciate that numerous additional computers and systems may be coupled to exchange computer system 100. Such computers and systems may include, without limitation, additional clearing systems, regulatory systems and fee systems.

The operations of computer devices and systems shown in FIG. 1 and described herein may be controlled by computer-executable instructions stored on one or more non-transitory computer-readable media. For example, computer device 116 may include computer-executable instructions for receiving market data from exchange computer system 100 and displaying that information to a user. As another example, modules 142 and/or 144 and/or other modules of exchange computer system 100 may include one or more non-transitory computer-readable media storing computer-executable instructions for performing herein-described operations.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

In at least some embodiments, exchange computer system 100 (or “computer system 100”) receives, stores, generates and/or otherwise processes data in connection with establishing and implementing price limits. Implementation of established price limits can include accepting and rejecting orders for financial products based on comparison of order prices to established price limits.

To avoid confusion, a distinction is drawn between financial products and financial product types. “Financial product type” refers to a category of contracts or other type of property interest. Examples of a financial product type may include, without limitation, a category of futures contracts having many of the same terms (e.g., same underlying subject matter, same delivery date, same delivery requirements, etc.), a category of forwards having many of the same terms, a category of swaps having many of the same terms, a category of options having many of the same terms (e.g., same optioned contract or other subject matter, same exercise requirements, etc.), a category of other derivative contracts having many of the same terms, a category of debt securities having many of the same terms (e.g., maturity date, par value, interest payment terms), and a category of equity securities having many of the same terms (e.g., issuer, voting class). “Financial product” refers to an actual contract or other interest that may be held by a market participant. A financial product is an instance of a financial product type. A financial product may result from matching of a buy order and a sell order.

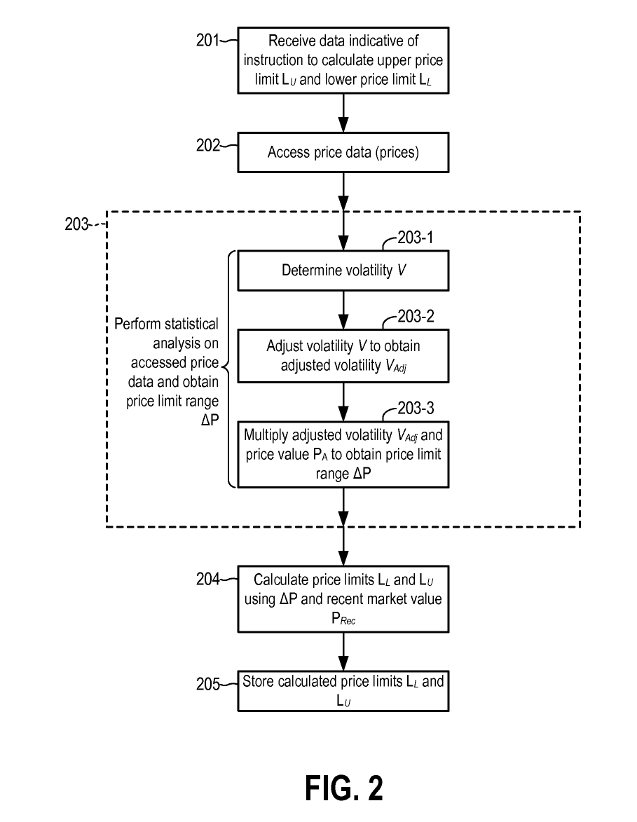

FIGS. 2 through 5 are flow charts showing operations performed by computer system 100, according to at least some embodiments, in connection with establishing and implementing price limits for a single hypothetical financial product type. For convenience, that hypothetical financial product type is called the “A product type.” The A product type could be a type of futures contract, a type of forward contract, a type of security, or some other type of financial product. An instance of the A product type will be called an “A product.” If the A product type is a type of futures contract, for example, an A product would be an individual futures contract. Although the operations of FIGS. 2 through 5 are described using the A product type as an example, computer system 100 may separately perform similar operations in connection other types of financial products.

FIG. 2 shows operations performed by computer system 100, in some embodiments, to establish upper and lower price limits L_{U} and L_{L} for the A product type. In step 201, price limit module 142 (FIG. 1) receives data indicative of an instruction to calculate an upper price limit L_{U} and a lower price limit L_{L} for the A product type. In some embodiments, price limits may be calculated at scheduled times, with price limits calculated at a particular scheduled time remaining in effect until a new set of price limits is calculated at the next scheduled time. In such an embodiment, the data received in step 201 may be an automatically-generated message indicating that a scheduled price limits calculation time has arrived. Such a message could be generated with module 142, by another module of computer system 100, or by another source.

The time interval between calculations of price limits may be one day, one week, two weeks, one month, two months, or some other duration. The time intervals need not be constant. For example, price limits might be calculated more frequently during months when trading in instances of a financial product type has normally been heavy and calculated less frequently when such trading has normally been lighter. The frequency of price limits calculation may also vary based on financial product type, e.g., price limits may be calculated more frequently for the A product type and less frequently for a B product type.

In step 202, and in response to the data received in step 201, module 142 accesses price data. That price data represents price information for instances of the A product type at each of N prior times, where N is an integer greater than 1. In some embodiments according to FIG. 2, the accessed data represents N prices P₁ through P_{N}, with each of the N prices being a price for A products at a different one of the N prior times. In other words, P₁ is a price for A products at prior time 1, P₂ is a price for A products at prior time 2, etc., with P_{N} being a price for A products at time N. In some embodiments, each of the N prior times corresponds to a separate trading day for A products. For example, time 1 may be the close of trading day D₁ preceding the time at which price limits are being calculated, time 2 may be the close of trading day D₂ immediately preceding D₁, etc., with time N being the close of trading day D_{N} immediately preceding trading day D_{N-1}. Each price P may be a price that represents a value of A products at the end of a different one of those trading days. That price could be, e.g., a closing trade price. Continuing the previous example, P₁ may be the closing trade price for A products on trading day D₁, P₂ may be the closing trade price for A products on trading day D₂, etc.

A price P may be a value other than a closing trade price, but which nonetheless represents a value for A products at a particular time. As but one example, a price P could be a final settlement price calculated according to established exchange rules. A final settlement price may or may not be the same as the closing trade price. As another example, a price P could be a midpoint between bid and ask offers or an average of bid-ask midpoints over some time period during a particular trading day.

In some embodiments, the time period spanning the N prior times may be the same as the time between price limits calculations. In some such embodiments, the value of N may be the number of A product trading days between the time of the current A product type price limits calculation and the time of the last A product type price limits calculation. In other embodiments, the time period spanning the N prior times may be greater or less than the time between price limits calculations. For example, price limits might be calculated monthly, with each set of calculations based on prices at each trading day during the immediately preceding year (e.g., price limits calculation in January of 2015 based on prices from January 2014 through December 2014, price limits calculation in February 2015 based on prices from February 2014 through January 2015, etc.). In some embodiments, the time period spanning the N prior times may be longer when price limits are calculated less frequently and shorter when price limits are calculated more frequently.

In step 203, module 142 performs a statistical analysis on the data accessed in step 202 and obtains a price limit range ΔP. In the embodiment of FIG. 2, step 203 includes three sub-steps 203-1, 203-2 and 203-3.

In step 203-1, module 142 determines a volatility V that quantifies a change in prices for instances of the A product type over a volatility window period. That volatility window may be the same as the time period spanning the N prior times. The volatility V may be a standard deviation or other statistical measure of prices contained in the data accessed in step 202. In some embodiments, module 142 determines a volatility Vas a standard deviation according to Equation 1.

$$V = \sqrt{d * {\sum }_{t = 2}^{t = N} \frac{{[ ln ( {P}_{t} / {P}_{t - 1} ) ]}^{2}}{N - 1}}$$

In Equation 1, the variable d represents an annualization factor equal to the number of days in a trading year, typically 252. The value of the summation counter variable t is used to indicate indicating one of the N time periods and the price corresponding to that time period. In particular, Pₜ and Pₜ₋₁ are the prices corresponding to time t and time t−1, respectively. Continuing a previous example, P₁ may be price P₁ corresponding to trading day D₁, P₂ may be price P₂ corresponding to trading day D₂, etc., with P_{N} being price P_{N} corresponding to trading day D_{N}.

A volatility V calculated according to Equation 1, with d=252, quantifies a change in A product prices applicable to a volatility window representing a trading year. In some embodiments, the volatility window may be changed by using a different value for d. The volatility window might also or alternatively be changed by scaling a volatility V. For example, it may be desirable for price limits to be based on volatility over a shorter time period (e.g., one half year, one quarter year). In such a case, a volatility V calculated with Equation 1 and d=252 can be scaled by \sqrt{(d′/d)}, where d′ is the number of trading days in a shorter time period of interest.

In other embodiments, module 142 may calculate volatility V in a different manner. For example, Equation 1 can be modified. As another example, module 142 may calculate a volatility V using the data accessed in step 202 and a stochastic volatility model. Examples of stochastic volatility models include, without limitation, any of the following: a generalized autoregressive conditional heteroskedasticity (GARCH) model, a Heston model, a constant elasticity of variance (CEV) model, a stochastic alpha, beta, rho (SABR) model, a 3/2 model or a Chen model.

In step 203-2, module 142 adjusts the volatility V from step 203-1 based on a predefined confidence level and obtains an adjusted volatility V_{Adj}. In some embodiments, module 142 adjusts volatility V by first obtaining a two-tail Z value corresponding to a predetermined percentile associated with a desired confidence level. A two-tail Z value is a known probability parameter. Tables mapping two-tail Z values to percentiles are well known. The predetermined percentile used by module 142 can be chosen based on a desired degree of confidence that the calculated price limits will cover an expected range of A product market prices over a forthcoming trading period. After obtaining the Z value corresponding to the predetermined percentile, that Z value and the volatility value V are multiplied to obtain V_{Adj}, i.e., V_{Adj}=V*Z|_{desired percentile}.

The following example illustrates this procedure. In this example, the predetermined confidence level is assumed to be 99%. A two-tail Z value representing the 99th percentile, and thus a confidence level of 99%, is approximately 2.58. If the volatility value V is 0.015 (i.e., 1.5%), the adjusted volatility V_{Adj} is 0.015*2.58, or 0.0387.

In step 203-3, module 142 obtains the price limit range ΔP using the adjusted volatility V_{Adj} from step 203-2 and P_{A}, a price value for A products. In at least some embodiments, ΔP=V_{Adj}*P_{A}. Price value P_{A} may be, e.g., a closing price, a final settlement price or some other price reflecting market value for A products at the end of an immediately preceding trading day. In some embodiments, price value P_{A} may simply be the price P₁ associated with the most recent of the N prior times. In other embodiments, P_{A} may have some other value, e.g., an opening market price for A products on a current trading day.

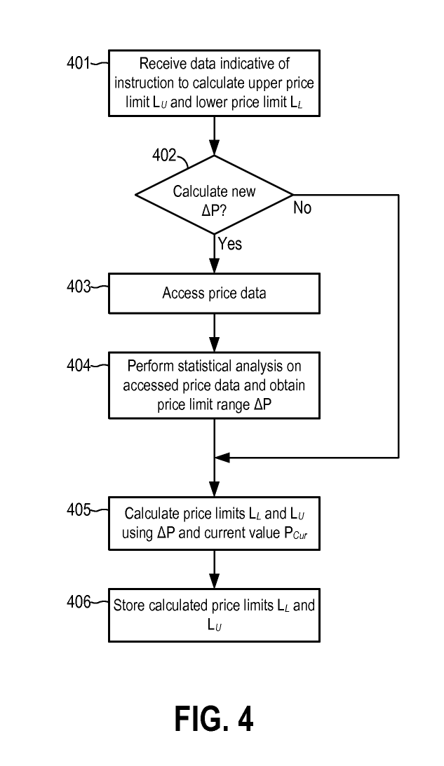

In step 204, module 142 calculates a upper price limit L_{U} and a lower price limit L_{L} for the A product type using the price limit range ΔP from step 203-3 and using P_{Rec}, a recent market value for A products. In some embodiments, the upper price limit L_{U} is calculated as P_{Rec}+ΔP and the lower price limit L_{L} is calculated as P_{Rec}−ΔP. The A product recent market value P_{Rec} used in step 204 may be the price value P_{A} used to find price limit range ΔP in step 203-3, or P_{Rec} may be a different value. For example, in some embodiments P_{A} is a closing trade price or final settlement price associated with the most recent of the N prior times, while P_{Rec} is an opening market price for A products on a subsequent trading day. As another example, there may be a lag of several trading days between the period of time represented by the data accessed in step 202 and the calculation of upper and lower price limits L_{U} and L_{L}. In such a circumstance, P_{Rec} may be a closing trade price, final settlement value, or other value from the trading day immediately preceding the time at which price limits are calculated. As yet another example, and as further described below in connection with FIG. 4, in some embodiments the upper and lower price limits may be calculated more frequently than the price limit range ΔP. In some such embodiments, P_{Rec} used to calculate L_{U} and L_{L} may be a market value corresponding to the time at which L_{U} and L_{L} are calculated, while P_{A} may be a price value corresponding to the time at which AP was calculated.

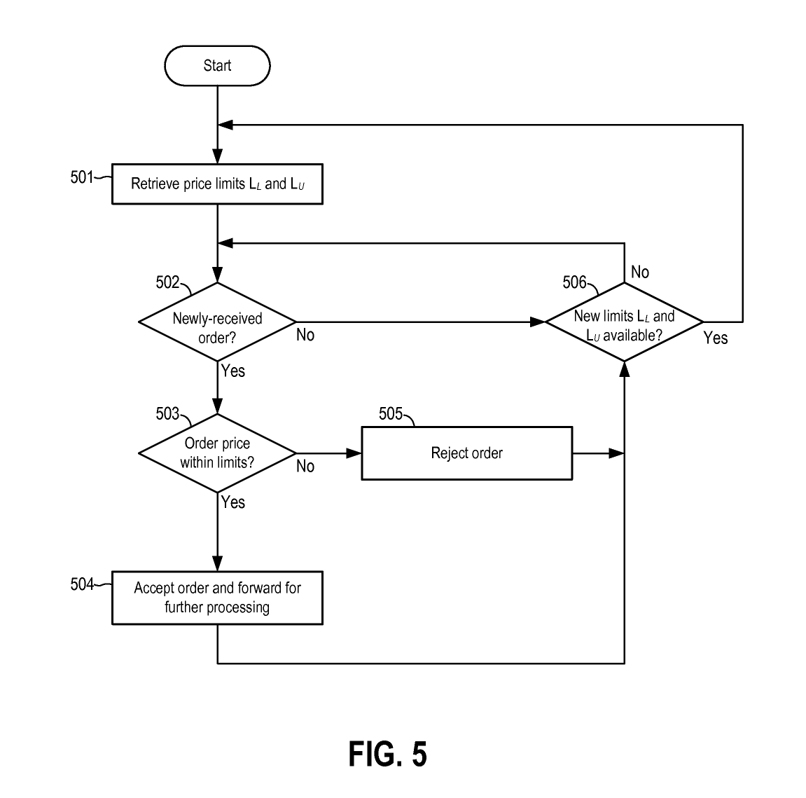

In step 205, module 142 stores the upper price limit L_{U} and the lower price limit L_{L} calculated in step 204. Those stored price limits may be retrieved by order acceptance/rejection module 144 for use in determining whether to accept or reject incoming orders for A products. Operations of module 144 are discussed below in connection with FIG. 5.

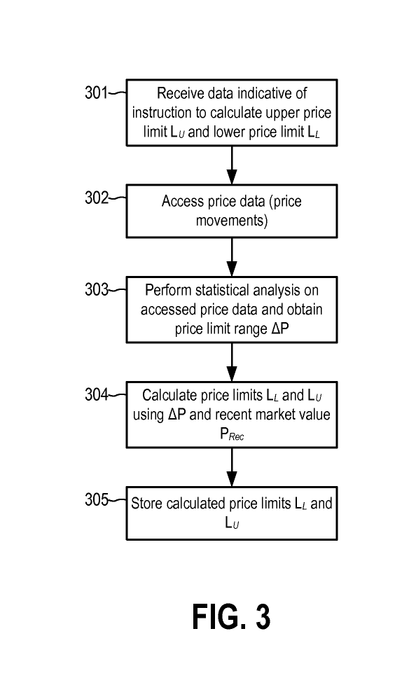

FIG. 3 shows operations performed by computer system 100, in some embodiments, to establish upper and lower price limits L_{U} and L_{L} for the A product type. FIG. 3 represents a modified version of the method shown in FIG. 2. In step 301, which may be performed in a manner similar to step 201 of FIG. 2, price limit module 142 (FIG. 1) receives data indicative of an instruction to calculate an upper price limit L_{U} and a lower price limit L_{L} for the A product type. In step 302, and in response to the data received in step 301, module 142 accesses price data. As with step 202 of FIG. 2, the data accessed in step 302 represents price information for instances of the A product type at each of N prior times.

In embodiments according to FIG. 3, however, the accessed price data represents N price movements M₁ through M_{N}, with each of the N price movements representing an amount by which a price for A products changed on a different one of the N prior times. In some such embodiments, each of the prior N times is a different trading day and a price movement M is a difference between the highest and lowest prices at which A products traded on a particular trading day. In other embodiments, a price movement M may be determined in another manner. For example, a price movement M could represent the absolute value of a difference between opening and closing A product prices on a trading day. As another example, a price movement M for trading day D_{J} could represent an absolute value of a difference between a closing price for A products on trading day D_{J} and a closing price for A products on trading day D_{J-1}. As but another example, prices other than closing prices (e.g., final settlement prices, bid-ask midpoints) could be used to determine price movements. For example, a price movement M for trading day D_{J} could be a difference between the highest average bid-ask midpoint during some continuous 5 minute period on D_{J} and the lowest bid-ask midpoint during some continuous 5 minute period on D. In some embodiments, the price movements represented by the data accessed in step 302 could be movements over some period other than a single trading day (e.g., a price movement over a part of a trading day, a price movement over multiple trading days).

In step 303, module 142 performs a statistical analysis on the price data accessed in step 302 and obtains a price limit range ΔP. In some embodiments, the statistical analysis of step 303 includes calculating a value M_{R} representing the Rth percentile of the price movements M₁ through M_{N} obtained in step 302. The price limit range ΔP is then set to equal M_{R}. The Rth percentile may be, e.g., 90th percentile, the 95th percentile, the 99th percentile, or some other value. The percentile may be chosen to correspond to a desired confidence level. Any of numerous known algorithms for calculating a specified percentile from a dataset can be used in connection with step 303. As but one example, the PERCENTILE function in the EXCEL spreadsheet software available from Microsoft Corporation returns a specified percentile of a specified array of values.

In step 304, module 142 calculates upper and lower price limits L_{U} and L_{L} for the A product type in a manner similar to that described in connection with step 204 of FIG. 2, but using the price limit range ΔP from step 303. In step 305, module 142 stores the calculated upper and lower price limits L_{U} and L_{L}. Those stored price limits may be retrieved by order acceptance/rejection module 144 for use in determining whether to accept or reject incoming orders for A products.

As indicated above, in some embodiments computer system 100 calculates the upper and lower price limits L_{U} and L_{L} more frequently than the price limit range ΔP. For example, in some such embodiments module 142 may calculate the upper and lower price limits for the A product type daily, but may only calculate the price limit range ΔP for the A product type on a monthly basis.

FIG. 4 is a flow chart showing operations of module 142 according to some additional embodiments. Step 401 is similar to step 201 of FIG. 2 and step 301 of FIG. 3. In step 401, price limit module 142 (FIG. 1) receives data indicating an instruction to calculate price limits for the A product type. In step 402, module 142 determines if it is a scheduled time for calculating price limit range ΔP. If not (“no” branch), module 142 proceeds to step 405 (discussed below). If it is a scheduled time for calculation of AP (“yes” branch), module 142 proceeds to step 403. In step 403, module 142 accesses price data. In some embodiments, step 403 is similar to step 202 of FIG. 2 and the data accessed in step 403 represents N prices P₁ through P_{N}, with each of the N prices being a price for A products at a different one of the N prior times. In some other embodiments, step 403 is similar to step 302 of FIG. 3 and the data accessed in step 403 represents N price movements M₁ through M_{N}, with each of the N price movements representing the amount by which a price for A products changed on a different one of the N prior times.

In step 404, module 142 performs a statistical analysis on the data accessed in step 403 and obtains a price limit range ΔP. In some embodiments where step 403 is similar to step 202 of FIG. 2, step 404 is similar to step 203 of FIG. 2. In some embodiments where step 403 is similar to step 302 of FIG. 3, step 404 is similar to step 303 of FIG. 3. At the conclusion of step 404, module 142 stores the price limit range ΔP.

In step 405, module 142 calculates an upper price limit L_{U} and a lower price limit L_{L} for the A product type using a current value for A products P_{Cur} and the value for AP stored in the last performance of step 404. In some embodiments, the upper price limit L_{U} is calculated as P_{Cur}+ΔP and the lower price limit L_{L} is calculated as P_{Cur}−ΔP The current value P_{Cur} may be a recent market value for A products (P_{Rec}) as discussed in connection with steps 204 (FIG. 2) and steps 304 (FIG. 3). In some embodiments, the current value P_{Cur} may be a banding start price determined using a method such as those described in commonly owned U.S. Pat. No. 8,666,875 (titled “Determination of Banding Start Price for Order Evaluation”), incorporated by reference herein.

In step 406, which may be similar to step 205 of FIG. 2 and step 305 of FIG. 3, module 142 stores the calculated upper and lower price limits L_{U} and L_{L}. In some embodiments, order acceptance/rejection module 144 subsequently retrieves those stored limits L_{U} and L_{L} for use in determining whether to accept or reject incoming orders for A products. In some embodiments, module 142 may forward the limits L_{U} and L_{L} to module 144 and/or to other modules and/or to other computer systems (e.g., to a web server for dissemination to market participants via an exchange web page).

FIG. 5 is a flow chart showing operations performed by computer system 100 when implementing price limits calculated according to FIG. 2, FIG. 3 or FIG. 4. In some embodiments, the operations of FIG. 5 may be performed by order acceptance/rejection module 144. In other embodiments, the operations of FIG. 5 may be performed by one or more other modules of computer system 100 or by one or more other computer systems.

In step 501, module 144 retrieves price limits L_{U} and L_{L} stored by module 142 and stores those price limits for use in step 504 (described below). In step 502, module 144 determines if there is a newly-received order for one or more A products. If not (“no” branch), module 144 proceeds to step 506. Step 506 is described below. If there is a newly-received A product order (“yes” branch), module 144 proceeds to step 503.

In step 503, module 144 determines if a bid price contained in the newly-received A product order (if that order is a bid) or an ask price contained in the newly-received A product order (if that order is an ask) is within the price limits or outside the price limits. If both of the upper and lower price limits are defined as non-inclusive, then an order price P_{Ord} is within the price limits if L_{L}<P_{Ord}<L_{U} and is outside the price limits if P_{Ord}≦L_{L} or if P_{Ord}≧L_{U}. If both of the upper and lower price limits are defined as inclusive, then an order price P_{Ord} is within the price limits if L_{L}≦P_{Ord}≦L_{U} and is outside the price limits if P_{Ord}<L_{L} or if P_{Ord}>L_{U}. If the upper price limit is defined as inclusive and the lower price limit is defined as non-inclusive, then an order price P_{Ord} is within the price limits if L_{L}<P_{Ord}≦L_{U} and is outside the price limits if P_{Ord}≦L_{L} or if P_{Ord}>L_{U}. If the upper price limit is defined as non-inclusive and the lower price limit is defined as inclusive, then an order price P_{Ord} is within the price limits if L_{L}≦P_{Ord}<L_{U} and is outside the price limits if P_{Ord}<L_{L} or if P_{Ord}≧L_{U}.

If the bid or ask price in the newly-received A product order is within the limits (“yes” branch), module 144 proceeds to step 504. In step 504, the newly-received A product order is accepted and forwarded for further processing. That further processing may include storing in an order book database (by module 110) and subsequent matching (by engine 106) against a separate ask order (if the newly-received order is a bid) or against a separate bid order (if the newly-received order is an ask). From step 504, module 144 proceeds to step 506 (described below).

If module 144 determines in step 503 that the price in the newly-received A product order is outside the price limits (“no” branch), module 144 proceeds to step 505. In step 505, the newly-received order is rejected and is not forwarded for further processing. As part of step 505, however, module 144 may transmit data indicating rejection of the order. From step 505, module 144 proceeds to step 506.

In step 506, module 144 determines if new price limits L_{U} and L_{L} have been calculated for the A product type. For example, module 144 may store data indicating a schedule for updating those limits and the scheduled update time may have arrived. As another example, module 142 may set a flag when new price limits L_{U} and L_{L} have been calculated and are available for retrieval, and the determination of step 506 may comprise checking the status of that flag. If new price limits are available (“yes” branch), module 144 returns to step 501. If new limits are not available (“no” branch), module 144 returns to step 503.

As can be appreciated from FIG. 5, steps 502 through 505 may be repeated for each of numerous bid and ask orders. Each of those orders may be an order for one or more A products and may include an order price representing an amount the order submitter will pay or accept for each A product.

In some embodiments, price data accessed by module 142 in step 202, step 302 or step 403 may include price data for a product type other than the A product type, but that data may nonetheless be representative of A product pricing or price movement. For example, trading in A products may be light or sporadic, but there may be an analogous product type for which there is heavier trading activity. For example, prices for instances of a product type B may have historically tracked prices for A products. In such a circumstance B product price data may provide a suitable proxy for A product price data.

### CONCLUSION

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention.

1. A method comprising:
receiving, by a computer system, data indicative of an instruction to calculate an upper price limit and a lower price limit corresponding to a financial product type;
accessing, by the computer system, data representing price information for each of N prior times, where N is an integer greater than 1;
performing, by the computer system, a statistical analysis of the price information to obtain a price limit range;
calculating, by the computer system, the upper price limit and the lower price limit based on the price limit range and based on a price value for instances of the financial product type; and
storing the calculated upper price limit and the calculated lower price limit by the computer system.

2. The method of claim 1, comprising:
receiving, by the computer system, data representing a first order for one or more instances of the financial product type;
determining, by the computer system, that a first price contained in the first order is within the calculated upper and lower price limits;
forwarding, by the computer system and based on the first price being within the calculated upper and lower price limits, the first order for further processing;
receiving, by the computer system, data representing a second order for one or more instances of the financial product type;
determining, by the computer system, that a second price contained in the second order is outside the calculated upper and lower price limits; and
rejecting the second order by the computer system based on the second price being outside the calculated upper and lower price limits.

3. The method of claim 2 wherein the accessing data comprises accessing data that represents N prices, each of the N prices being a price for instances of the financial product type at a different one of the N prior times.

4. The method of claim 3 wherein
performing the statistical analysis comprises (i) determining a volatility that quantifies a change in prices for instances of the financial product type over a volatility window period, (ii) adjusting the determined volatility based on a predefined confidence level to obtain an adjusted volatility, and (iii) multiplying the adjusted volatility and a price value to obtain the pricing range, and
calculating the upper price limit comprises adding the price limit range to a current price value and calculating the lower price limit comprises subtracting the price limit range from the current price value.

5. The method of claim 4 wherein determining the volatility comprises determining a volatility V according to the formula
$$V = \sqrt{d * {\sum }_{t = 2}^{t = N} \frac{{[ ln ( {P}_{t} / {P}_{t - 1} ) ]}^{2}}{N - 1}} ,$$
and wherein d is an annualization factor representing a number of days in a trading year, t is a time during one of the N time periods, Pₜ is a price corresponding to time t, and Pₜ₋₁ is a price corresponding to time t−1.

6. The method of claim 4 wherein determining a volatility comprises determining a volatility according to a stochastic volatility model.

7. The method of claim 6 wherein the stochastic volatility model is one of generalized autoregressive conditional heteroskedasticity model, a Heston model, a constant elasticity of variance model, a stochastic alpha, beta, rho model, a 3/2 model or a Chen model.

8. The method of claim 2 wherein
each of the N prior times corresponds to a different one of N separate time periods,
accessing the data comprises accessing data that represents N price movements, each of the N price movements representing a price change for instances of the financial product type during a different one of the N time periods,
performing the statistical analysis comprises calculating the price limit range as a predefined percentile of the N price movements, and
calculating the upper price limit comprises adding the price limit range to a current price value and calculating the lower price limit comprises subtracting the price limit range from the current price value.

9. One or more non-transitory computer-readable media storing computer executable instructions that, when executed, cause a computer system to perform operations that include:
receiving data indicative of an instruction to calculate an upper price limit and a lower price limit corresponding to a financial product type;
accessing data representing price information for each of N prior times, where N is an integer greater than 1;
performing a statistical analysis of the price information to obtain a price limit range;
calculating the upper price limit and the lower price limit based on the price limit range and based on a price value for instances of the financial product type; and
storing the calculated upper price limit and the calculated lower price limit.

10. The one or more non-transitory computer-readable media of claim 9, further comprising stored computer executable instructions that, when executed, cause a computer system to perform operations that include:
receiving data representing a first order for one or more instances of the financial product type;
determining that a first price contained in the first order is within the calculated upper and lower price limits;
forwarding, based on the first price being within the calculated upper and lower price limits, the first order for further processing;
receiving data representing a second order for one or more instances of the financial product type;
determining that a second price contained in the second order is outside the calculated upper and lower price limits; and
rejecting the second order based on the second price being outside the calculated upper and lower price limits.

11. The one or more non-transitory computer-readable media of claim 10 wherein the accessing data comprises accessing data that represents N prices, each of the N prices being a price for instances of the financial product type at a different one of the N prior times.

12. The one or more non-transitory computer-readable media of claim 11 wherein
performing the statistical analysis comprises (i) determining a volatility that quantifies a change in prices for instances of the financial product type over a volatility window period, (ii) adjusting the determined volatility based on a predefined confidence level to obtain an adjusted volatility, and (iii) multiplying the adjusted volatility and a price value to obtain the pricing range, and
calculating the upper price limit comprises adding the price limit range to a current price value and calculating the lower price limit comprises subtracting the price limit range from the current price value.

13. The one or more non-transitory computer-readable media of claim 12 wherein determining the volatility comprises determining a volatility V according to the formula
$$V = \sqrt{d * {\sum }_{t = 2}^{t = N} \frac{{[ ln ( {P}_{t} / {P}_{t - 1} ) ]}^{2}}{N - 1}} ,$$
and wherein d is an annualization factor representing a number of days in a trading year, t is a time during one of the N time periods, Pₜ is a price corresponding to time t, and Pₜ₋₁ is a price corresponding to time t−1.

14. The one or more non-transitory computer-readable media of claim 12 wherein determining a volatility comprises determining a volatility according to a stochastic volatility model.

15. The one or more non-transitory computer-readable media of claim 14 wherein the stochastic volatility model is one of generalized autoregressive conditional heteroskedasticity model, a Heston model, a constant elasticity of variance model, a stochastic alpha, beta, rho model, a 3/2 model or a Chen model.

16. The one or more non-transitory computer-readable media of claim 10 wherein
each of the N prior times corresponds to a different one of N separate time periods,
accessing the data comprises accessing data that represents N price movements, each of the N price movements representing a price change for instances of the financial product type during a different one of the N time periods,
performing the statistical analysis comprises calculating the price limit range as a predefined percentile of the N price movements, and
calculating the upper price limit comprises adding the price limit range to a current price value and calculating the lower price limit comprises subtracting the price limit range from the current price value.

17. A computer system comprising:
at least one processor; and
at least one non-transitory memory, wherein the at least one non-transitory memory stores instructions that, when executed, cause the computer system to perform operations that include
receiving data indicative of an instruction to calculate an upper price limit and a lower price limit corresponding to a financial product type,
accessing data representing price information for each of N prior times, where N is an integer greater than 1,
performing a statistical analysis of the price information to obtain a price limit range,
calculating the upper price limit and the lower price limit based on the price limit range and based on a price value for instances of the financial product type, and
storing the calculated upper price limit and the calculated lower price limit.

18. The computer system of claim 17 wherein the at least one non-transitory memory stores instructions that, when executed, cause the computer system to perform operations that include
receiving data representing a first order for one or more instances of the financial product type,
determining that a first price contained in the first order is within the calculated upper and lower price limits,
forwarding, based on the first price being within the calculated upper and lower price limits, the first order for further processing,
receiving data representing a second order for one or more instances of the financial product type,
determining that a second price contained in the second order is outside the calculated upper and lower price limits, and
rejecting the second order based on the second price being outside the calculated upper and lower price limits.

19. The computer system of claim 18 wherein the accessing data comprises accessing data that represents N prices, each of the N prices being a price for instances of the financial product type at a different one of the N prior times.

20. The computer system of claim 19 wherein
performing the statistical analysis comprises (i) determining a volatility that quantifies a change in prices for instances of the financial product type over a volatility window period, (ii) adjusting the determined volatility based on a predefined confidence level to obtain an adjusted volatility, and (iii) multiplying the adjusted volatility and a price value to obtain the pricing range, and
calculating the upper price limit comprises adding the price limit range to a current price value and calculating the lower price limit comprises subtracting the price limit range from the current price value.

21. The computer system of claim 20 wherein determining the volatility comprises determining a volatility V according to the formula
$$V = \sqrt{d * {\sum }_{t = 2}^{t = N} \frac{{[ ln ( {P}_{t} / {P}_{t - 1} ) ]}^{2}}{N - 1}} ,$$
and wherein d is an annualization factor representing a number of days in a trading year, t is a time during one of the N time periods, Pₜ is a price corresponding to time t, and Pₜ₋₁ is a price corresponding to time t−1.

22. The computer system of claim 20 wherein determining a volatility comprises determining a volatility according to a stochastic volatility model.

23. The computer system of claim 22 wherein the stochastic volatility model is one of generalized autoregressive conditional heteroskedasticity model, a Heston model, a constant elasticity of variance model, a stochastic alpha, beta, rho model, a 3/2 model or a Chen model.

24. The computer system of claim 18 wherein
each of the N prior times corresponds to a different one of N separate time periods,
accessing the data comprises accessing data that represents N price movements, each of the N price movements representing a price change for instances of the financial product type during a different one of the N time periods,
performing the statistical analysis comprises calculating the price limit range as a predefined percentile of the N price movements, and
calculating the upper price limit comprises adding the price limit range to a current price value and calculating the lower price limit comprises subtracting the price limit range from the current price value.
